(19) United States
(12) Patent Application Publication
(10) Pub. No.: US 2013/0101106 A1
(43) Pub. Date: Apr. 25, 2013

(54) Processing Data

(71) Applicants: Chris Mairs, Enfield (GB); Liz Rice, Enfield (GB); Philip Pearl, Enfield (GB); Felix Palmer, Enfield (GB); David Drysdale, London (GB); Shaun Crampton, Enfield (GB); Michael Bell, Edinburgh (GB)

(72) Inventors: Chris Mairs, Enfield (GB); Liz Rice, Enfield (GB); Philip Pearl, Enfield (GB); Felix Palmer, Enfield (GB); David Drysdale, London (GB); Shaun Crampton, Enfield (GB); Michael Bell, Edinburgh (GB)

(73) Assignee: METASWITCH NETWORKS LTD., Enfield (GB)

(21) Appl. No.: 13/570,145

(22) Filed: Aug. 8, 2012

Related U.S. Application Data
(60) Provisional application No. 61/521,182, filed on Aug. 8, 2011.

(51) Int. Cl. H04M 3/56

(52) U.S. Cl. CPC H04M 3/56
USPC 379/202.01

(57) ABSTRACT

A method of processing data in relation to a teleconference service in a telecommunications network is provided. The teleconference service is able to handle a multi-party teleconference for three or more teleconference participants. First, second and third teleconference participation identifiers are received from first, second and third teleconference participants respectively. The first, second and third teleconference participation identifiers are correlated to determine that the first, second and third teleconference participants are participants in a given multi-party teleconference. Data is transmitted for enabling the establishment of a data communications session which is established separately from the teleconference. The data communications session is for the communication of data between a first data communication device associated with the first teleconference participant, a second data communication device associated with the second teleconference participant and a third data communication device associated with the third teleconference participant.

### CROSS-REFERENCE TO RELATED APPLICATIONS

This application is a Nonprovisional of U.S. Patent Application Ser. No. 61/521,182, filed on Aug. 8, 2011, the disclosure of which is incorporated herein by reference in its entirety.

### TECHNICAL FIELD

The present invention relates to methods of and apparatus for processing data.

### BACKGROUND

Communication between parties in a telecommunications network can be carried out in a number of ways. Most commonly, communication is carried out by a calling party dialing a telephone dialing number associated with a called party telephony device on a calling party telephony device. The dialing of the telephone number causes a call setup process to be carried out in the network which results in the telephone of the called party ringing. If the called party chooses to answer their telephone, a telephone call can ensue between the calling party and the called party. The telephone call allows audio data such as speech data to be transferred along an audio channel created between the calling party telephony device and the called party telephony device.

Audio or video conferencing may be carried out between three or more remote telephony devices, allowing communication of audio and/or video data between parties to the teleconference.

Web conferencing is also possible between multiple remote parties using devices with combined data processing, display and telephony capabilities. Web conferencing allows online meetings to be conducted for viewing and/or collaborating on common multimedia content.

The exemplary methods of communication described above provide a wide range of options for remote parties to communicate with each other. However, each method typically has different requirements in terms of device and/or network capability and interchanging between the different methods is either not possible or requires use of inconvenient set-up or configuration processes.

It would therefore be desirable to provide improved and/or additional methods and apparatus for communicating data between remote parties.

### SUMMARY

According to a first aspect of the invention, there is provided a method of processing data in relation to a teleconference service in a telecommunications network, the teleconference service being able to handle a multi-party teleconference for three or more teleconference participants, the method comprising receiving a first teleconference participation identifier from a first teleconference participant, receiving a second teleconference participation identifier from a second teleconference participant, receiving a third teleconference participation identifier from a third teleconference participant, correlating the first, second and third teleconference participation identifiers to determine that the first, second and third teleconference participants are participants in a given multi-party teleconference, and transmitting data for enabling the establishment of a data communications session which is established separately from the teleconference, the data communications session being for the communication of data between a first data communication device associated with the first teleconference participant, a second data communication device associated with the second teleconference participant and a third data communication device associated with the third teleconference participant. Hence, a data communications session can be established separately from the teleconference for the communication of data between the teleconference participants which are determined to be participants in the given multi-party teleconference. The data communications session may, for example, enable data that cannot be transmitted via the teleconference to be transferred to and/or between the teleconference participants.

In some embodiments, the first teleconference participation identifier may be different from a telephone dialing number associated with the first data communication device, the second teleconference participation identifier may be different from a telephone dialing number associated with the second data communication device, and the third teleconference participation identifier may be different from a telephone dialing number associated with the third data communication device. As such, an identifier different from the telephone dialing numbers associated with the data communication devices can be used for correlation. The identifier may, for example, comprise a teleconference identifier for the given multi-party teleconference and/or a participant identifier for the teleconference participant.

Some embodiments may comprise establishing a first telephony session with the first teleconference participant and receiving the first teleconference participation identifier via the first telephony session, establishing a second telephony session with the second teleconference participant and receiving the second teleconference participation identifier via the second telephony session, and establishing a third telephony session with the third teleconference participant and receiving the third teleconference participation identifier via the third telephony session. Such embodiments provide a convenient method for obtaining the teleconference participation identifiers from the teleconference participants.

Some embodiments may comprise receiving first multi-frequency signalling information via the first telephony session and determining the first teleconference participation identifier from the first multi-frequency signalling information, receiving second multi-frequency signalling information via the second telephony session and determining the second teleconference participation identifier from the second multi-frequency signalling information, and receiving third multi-frequency signalling information via the third telephony session and determining the third teleconference participation identifier from the third multi-frequency signalling information. Such embodiments provide a mechanism for determining the teleconference participation identifiers from information received in the telephony sessions. In some cases, the multi-frequency signalling information may comprise Dual-tone Multi-frequency (DTMF) signalling information.

Some embodiments may comprise receiving the first teleconference participation identifier from the first teleconference participant via a first data communications session other than the first telephony session, receiving the second teleconference participation identifier from the second teleconference participant via a second data communications session other than the second telephony session and receiving the third teleconference participation identifier from the third teleconference participant via a third data communications session other than the third telephony session. Such embodiments provide an alternative convenient method for obtaining the teleconference participation identifiers from the teleconference participants.

Some embodiments may comprise receiving said first, second and third teleconference participation identifiers at a teleconference service provider that provides the teleconference service, performing said correlation at the teleconference service provider and transmitting said data for enabling the establishment of the data communications session to a communications session service provider, the communications session service provider establishing the data communications session separately from the teleconference. In such embodiments, an entity responsible for handling the teleconference may perform the correlation and another entity may establish the separate data communications session. In some such embodiments, the teleconference service provider may perform the correlation to place participants into the teleconference and provide the correlation data to the communications session service provider so that the communications session service provider can determine the participants for the teleconference but need not perform correlation itself. This may reduce processing overhead on the communications session service provider. In other such embodiments, the correlation data may comprise sufficient data for the communications session service provider to perform the correlation which it duly performs. This may reduce processing overhead on the teleconference service provider.

In some embodiments, said data for enabling the establishment of a data communications session may comprise correlation data identifying that the first, second and third teleconference participants are participants in the given multi-party teleconference. Such embodiments enable correlation to be performed and the results of the correlation to be used as a basis on which to establish the data communications session.

Some embodiments may comprise receiving said first, second and third teleconference participation identifiers at a communications session service provider that establishes data communications sessions and performing said correlation at the communications session service provider. In such embodiments, the communications session service provider can determine the participants for the teleconference.

Some embodiments may comprise receiving the first teleconference participation identifier from a first telephony device associated with the first teleconference participant, receiving the second teleconference participation identifier from a second telephony device associated with the second teleconference participant, receiving the third teleconference participation identifier from a third telephony device associated with the third teleconference participant, and wherein at least one of said first, second and third data communications devices is different from at least one of said first, second and third telephony devices. In such embodiments, the data communications session can be established with a data communications device, associated with a teleconference participant in the event that the telephony device associated with the teleconference participant is not capable of data communications. One or more of the telephony devices may conveniently be a mobile telephony device or an analogue telephone. One of more of the data communications devices may conveniently be a computing device, such as a Personal Computer (PC) or the like.

According to a second aspect of the invention, there is provided a method of processing data in relation to a teleconference service in a telecommunications network, the teleconference service being able to handle a multi-party teleconference for three or more teleconference participants, the method comprising receiving a first request to establish a data communications session from a first teleconference participant, receiving a second request to establish a data communications session from a second teleconference participant, receiving a third request to establish a data communications session from a third teleconference participant, determining that the first, second and third teleconference participants are participants in a given multi-party teleconference and establishing a data communications session separately from the teleconference, the data communication session being for the communication of data between a first data communications device associated with the first teleconference participant, a second data communications device associated with the second teleconference participant and a third data communications device associated with the third teleconference participant. Hence, a data communications session is established separately from the teleconference for the communication of data between the teleconference participants which are determined to be participants in the given multi-party teleconference. The data communications session may, for example, enable data that cannot be transmitted via the teleconference to be transferred to and/or between the teleconference participants.

Some embodiments may comprise receiving correlation data identifying that the first, second and third teleconference participants in the given multi-party teleconference from a teleconference service provider that provides that teleconference service. In such embodiments, the teleconference service provider may perform correlation to identify that the teleconference participants are participants in the given teleconference and the result of the correlation can be used as a basis on which to establish the data communications session separately from the teleconference.

Some embodiments may comprise receiving said first request from a first mobile telephony device associated with the first teleconference participant, receiving said second request from a second mobile telephony device associated with the second teleconference participant, and receiving said third request from a third mobile telephony device associated with the third teleconference participant, and wherein at least one of said first, second and third data communications devices is different from at least one of said first, second and third telephony devices. In such embodiments, the data communications session is established with a data communications device, associated with a teleconference participant in the event that the telephony device associated with the teleconference participant is not capable of data communications. One or more of the telephony devices may conveniently be a mobile telephony device or an analogue telephone. One of more of the data communications devices may conveniently be a computing device, such as a Personal Computer (PC) or the like.

Some embodiments may comprise receiving a first teleconference participation identifier from the first teleconference participant, receiving a second teleconference participation identifier from the second teleconference participant, receiving a third teleconference participation identifier from the third teleconference participant and correlating the first, second and third teleconference participation identifiers to determine that the first, second and third teleconference participants are participants in a given multi-party teleconference. Such embodiments provide a method of determining that the teleconference participants are participants in the given teleconference, by performing correlation based on the teleconference participation identifiers which are received from respective teleconference participants.

According to a third aspect of the invention, there is provided a method of processing data in relation to a teleconference service in a telecommunications network, the teleconference service being able to handle a multi-party teleconference for three or more teleconference participants, the method comprising obtaining a first teleconference participation identifier associated with a given multi-party teleconference involving a first teleconference participant, transmitting the teleconference participation identifier via a data communications session that is separate from the multi-party teleconference, establishing a multi-party data communications session for the communication of data between a first data communication device associated with the first teleconference participant, a second data communication device associated with a second teleconference participant and a third data communication device associated with a third teleconference participant, the first, second and third teleconference participants being participants in the given multi-party teleconference. Hence, a multi-party data communications session is established separately from the teleconference for the communication of data between the teleconference participants which are determined to be participants in the given multi-party teleconference. The data communications session may, for example, enable data that cannot be transmitted via the teleconference to be transferred to and/or between the teleconference participants.

Some embodiments may comprise establishing a telephony session with a teleconference service provider that provides the given multi-party teleconference, and transmitting the teleconference participation identifier via the telephony session. Such embodiments provide a convenient method for providing the teleconference participation identifiers to the teleconference service provider.

Some embodiments may comprise transmitting multi-frequency signalling information via the telephony session, the multi-frequency signalling information comprising the teleconference participation identifier. Such embodiments provide a mechanism for providing the teleconference participation identifier to the teleconference service provider. In some cases, the multi-frequency signalling information may comprise Dual-tone Multi-frequency (DTMF) signalling information.

Some embodiments may comprise receiving the teleconference participation identifier via an input mechanism, transmitting the teleconference participation identifier received via the input mechanism to the teleconference service provider, capturing the teleconference participation identifier, and transmitting the captured teleconference participation identifier to a communications session service provider. Such embodiments may result in less interaction with a user, resulting an in improved user experience.

Some embodiments may comprise receiving the teleconference participation identifier via an input mechanism, transmitting the teleconference participation identifier received via the input mechanism to a communications session service provider, capturing the teleconference participation identifier, and transmitting the captured teleconference participation identifier to the teleconference service provider. Such embodiments may result in less interaction with a user, resulting an in improved user experience.

According to a fourth aspect of the invention, there is provided apparatus for processing data in relation to a teleconference service in a telecommunications network, the teleconference service being able to handle a multi-party teleconference for three or more teleconference participants, the apparatus being configured to receive a first teleconference participation identifier from a first teleconference participant, receive a second teleconference participation identifier from a second teleconference participant, receive a third teleconference participation identifier from a third teleconference participant, receive the first, second and third teleconference participation identifiers to determine that the first, second and third teleconference participants are participants in a given multi-party teleconference, and transmit data for enabling the establishment of a data communications session which is established separately from the teleconference, the data communications session being for the communication of data between a first data communication device associated with the first teleconference participant, a second data communication device associated with the second teleconference participant and a third data communication device associated with the third teleconference participant.

According to a fifth aspect of the invention, there is provided apparatus for processing data in relation to a teleconference service in a telecommunications network, the teleconference service being able to handle a multi-party teleconference for three or more teleconference participants, the apparatus being configured to receive a first request to establish a data communications session from a first teleconference participant, receive a second request to establish a data communications session from a second teleconference participant, receive a third request to establish a data communications session from a third teleconference participant, determine that the first, second and third teleconference participants are participants in a given multi-party teleconference, and establish a data communications session separately from the teleconference, the data communication session being for the communication of data between a first data communications device associated with the first teleconference participant, a second data communications device associated with the second teleconference participant and a third data communications device associated with the third teleconference participant.

According to a sixth aspect of the invention, there is provided apparatus for processing data in relation to a teleconference service in a telecommunications network, the teleconference service being able to handle a multi-party teleconference for three or more teleconference participants, the apparatus being configured to obtain a first teleconference participation identifier associated with a given multi-party teleconference involving a first teleconference participant, transmit the teleconference participation identifier via a data communications session that is separate from the multi-party teleconference, establish a multi-party data communications session for the communication of data between a first data communication device associated with the first teleconference participant, a second data communication device associated with a second teleconference participant and a third data communication device associated with a third teleconference participant, the first, second and third teleconference participants being participants in the given multi-party teleconference.

According to a seventh aspect of the invention, there is provided a computer program product comprising a non-transitory computer-readable storage medium having computer readable instructions stored thereon, the computer readable instructions being executable by a computerized device to cause the computerized device to perform a method for processing data in relation to a teleconference service in a telecommunications network, the teleconference service being able to handle a multi-party teleconference for three or more teleconference participants, the method comprising receiving a first teleconference participation identifier from a first teleconference participant, receiving a second teleconference participation identifier from a second teleconference participant, receiving a third teleconference participation identifier from a third teleconference participant, correlating the first, second and third teleconference participation identifiers to determine that the first, second and third teleconference participants are participants in a given multi-party teleconference, and transmitting data for enabling the establishment of a data communications session which is established separately from the teleconference, the data communications session being for the communication of data between a first data communication device associated with the first teleconference participant, a second data communication device associated with the second teleconference participant and a third data communication device associated with the third teleconference participant.

According to an eighth aspect of the invention, there is provided a computer program product comprising a non-transitory computer-readable storage medium having computer readable instructions stored thereon, the computer readable instructions being executable by a computerized device to cause the computerized device to perform a method of processing data in relation to a teleconference service in a telecommunications network, the teleconference service being able to handle a multi-party teleconference for three or more teleconference participants, the method comprising receiving a first request to establish a data communications session from a first teleconference participant, receiving a second request to establish a data communications session from a second teleconference participant, receiving a third request to establish a data communications session from a third teleconference participant, determining that the first, second and third teleconference participants are participants in a given multi-party teleconference, and establishing a data communications session separately from the teleconference, the data communication session being for the communication of data between a first data communications device associated with the first teleconference participant, a second data communications device associated with the second teleconference participant and a third data communications device associated with the third teleconference participant.

According to a ninth aspect of the invention, there is provided a computer program product comprising a non-transitory computer-readable storage medium having computer readable instructions stored thereon, the computer readable instructions being executable by a computerized device to cause the computerized device to perform a method of processing data in relation to a teleconference service in a telecommunications network, the teleconference service being able to handle a multi-party teleconference for three or more teleconference participants, the method comprising obtaining a first teleconference participation identifier associated with a given multi-party teleconference involving a first teleconference participant, transmitting the teleconference participation identifier via a data communications session that is separate from the multi-party teleconference and establishing a multi-party data communications session for the communication of data between a first data communication device associated with the first teleconference participant, a second data communication device associated with a second teleconference participant and a third data communication device associated with a third teleconference participant, the first, second and third teleconference participants being participants in the given multi-party teleconference.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic block diagram showing a telecommunications system according to preferred embodiments;

FIGS. 2A, 2B and 2C are flow diagrams showing a method of processing data according to preferred embodiments;

FIG. 3 is a schematic block diagram showing a telecommunications system according to preferred embodiments;

FIG. 4 is a front view of a mobile telephony device according to preferred embodiments;

FIG. 5 is a front view of a mobile telephony device according to preferred embodiments;

FIG. 6 is a front view of a mobile telephony device according to preferred embodiments;

FIG. 7 is a front view of a mobile telephony device according to preferred embodiments; and

FIGS. 8A, 8B and 8C are flow diagrams showing a method of processing data according to preferred embodiments.

### DETAILED DESCRIPTION

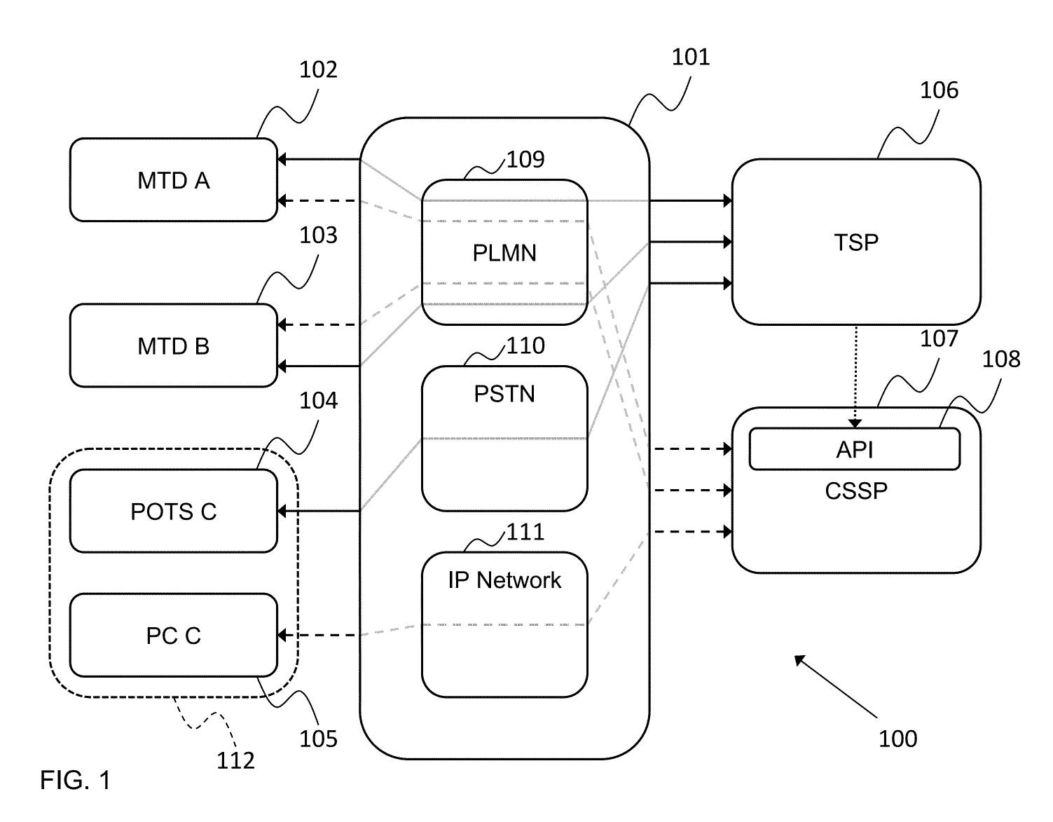

FIG. 1 is a schematic block diagram showing a telecommunications system 100 according to some embodiments.

The telecommunications system 100 includes a telecommunications network 101, which provides telecommunications services to three telephony devices 102, 103, 104 and a computing device 105. The telecommunications system 100 also includes a network entity (hereinafter referred to as a teleconference service provider (TSP)) 106, such as a conference bridge, which provides teleconference services in the telecommunications system 100. The telecommunications system 100 additionally includes a network entity (hereinafter referred to as a communications session service provider (CSSP)) 107 which establishes data communications sessions in the telecommunications system 100. The CSSP 107 includes an Application Programming Interface (API) 108 that serves as an interface between the TSP 106 and the CSSP 107.

In this example, the telecommunications network 101 comprises a Public Switched Telephone Network (PSTN) part 109, a Public Land Mobile Network (PLMN) part 110 and an Internet Protocol (IP) network part 111.

The PSTN part 109 provides telephony services to fixed-line telephones (also called landline or wireline telephones). The PSTN 109 includes various exchange switches, including local telephone exchange switches (such as a ‘class 5’ switch) that provide telephony services to and from the fixed-line telephones.

The PLMN part 110 provides telephony services to mobile telephones (also called cellular telephones). The PLMN 110 contains mobile telephony network infrastructure including one or more mobile switching centres, one or more base station controllers, and one or more base transceiver stations. The function of such entities is well known in the art and will not be described in detail here.

The IP network part 111 provides data communications services to data communication devices, including computing devices such as Personal Computers (PCs), Personal Digital Assistants (PDAs), Set-top Boxes (STBs) and the like.

The telecommunications network 101 comprises one or more media and/or signalling gateway entities (not shown) for performing conversion between the various protocols and data formats used to transfer media and signalling data within and between the different network parts 109, 110 and 111.

In this example, telephony devices 102 and 103 are smart mobile telephony devices (MTDs) that are served by the PLMN 109. MTDs 102 and 103 are associated with mobile telephone users A and B respectively. MTDs 102 and 103 are hereinafter referred to as MTD A and B respectively.

MTD A and B have data processing capabilities and operating systems, and can connect to the PLMN 109 via respective radio interfaces. MTD A and B are both capable of establishing a telephony session with the TSP 106 and a separate data communications session with the CSSP 107.

MTD A has an associated identity in the form of a telephone dialing number (TDN), TDN A, which may by a Mobile Subscriber Integrated Services Digital Network (MSISDN) number. MTD B also has an associated identity in the form of a telephone dialing number TDN B, which may also be an MSISDN number. MTD A has communication session application software running on it with an associated application identifier APID A. MTD B also has communication session application software running on it with an associated application identifier APID B.

During installation of the application software on MTD, the CSSP 107 may be informed of APID A and may create a record for MTD A containing APID A stored in association with TDN A. Similarly, during installation of the application software on MTD B, the CSSP 107 may be informed of APID B and may create a record for MTD B containing APID B stored in association with TDN B.

In this example, telephony device 104, which is associated with user C, is an analogue telephone (sometimes referred to as a Plain Old Telephone Service (POTS) telephone or a ‘black phone’), which can connect to the PSTN 110. Telephony device 104 is hereinafter referred to as POTS C. POTS C has an associated telephone dialing number TDN C.

In this case, user C of POTS C cannot conduct data communications sessions (for example with the CSSP 107) separate to voice calls conducted using POTS C just using POTS C alone. User C additionally employs the computing device 105, which in this example is a PC, to conduct separate data communications sessions with the CSSP 107 via the PC. The PC 105 is hereinafter referred to as PC C. PC C has an associated network address in the form of an Internet Protocol (IP) address, IP C, in the IP network 111. PC C has communication session application software running on it, for facilitating communication sessions, with an associated application identifier APID C.

To provide both voice calls via POTS C and separate communication sessions via PC C, POTS phone and PC C are coupled together logically, as indicated by a dashed box 112 in FIG. 1.

The PSTN 110 includes a network element in the form of a call-switching element, sometimes referred to as a Service Switching Point (SSP), which is capable of detecting whether a query should be raised in relation to calls to/from particular TDNs (in this case TDN C) by analysing in-call signalling information for the calls. The SSP acts on behalf of the user C of POTS C and PC C and is configured to trigger a query, for example to hand call control, to a service control point (SCP) network node when it detects a predetermined call state for a call to/from TDN C associated with POTS C, for example by use of an Intelligent Network (IN) or Advanced Intelligent Network (AIN) call origination/termination trigger.

The SCP is a network node responsible for deciding upon how such queries should be dealt with and acting accordingly, for example responding to the SSP with appropriate instructions. The query from the SSP to the SCP may pass via one or more Signalling Transfer Points (STPs).

Upon receipt of in-call signalling information relating to a query from the SSP, the SCP is configured to trigger notification of such to the CSSP 107. Any such notification to the CSSP 107 includes call party details for the call.

Configuration of the SCP may involve storing an IP address for the CSSP 107 in association with TDN C associated with POTS C, such that when in-call signalling information relating to a call to/from POTS C is received, notification to the CSSP 107 at the stored IP address is triggered.

In this example, POTS C has no communication session application software running on it. Further, POTS C has no capability to generate notifications when a call is outgoing from or incoming to POTS C.

Instead, PC C has communication session application software running on it for facilitating communication sessions involving user C.

During installation of the communication session application software on PC C, the CSSP 107 is informed that PC C and POTS C are to be coupled together logically. PC C sends IP C and TDN C to the CSSP 107 which creates a record for user C containing IP C stored in association with TDN C.

The TSP 106 provides teleconferencing services to users A, B and C in the telecommunications system 100. Teleconferencing services may be used to transmit data between three or more remote parties. The data can include, but is not limited to being, audio and/or video data. The data can include various other forms of media data.

An initiating party that wishes to set up the teleconference typically contacts an organisation associated with the TSP 106 to schedule a teleconference. This may be, for example, by sending an e-mail or placing a phone call to the organisation associated with the TSP 106.

A teleconference is often scheduled some time in advance of its intended start time to give the participants for the teleconference sufficient time to prepare for the teleconference and/or to confirm that they are available for the teleconference at the scheduled time. An invitation for the teleconference is provided to all of the participants for the teleconference which indicates the scheduled start time for the teleconference and which includes joining instructions explaining how to join the teleconference at the scheduled time. The invitation and the joining instructions may be provided to the participants by e-mail, Short Messaging Service (SMS) message, telephone, by post or in another suitable manner.

The joining instructions may identify a dedicated TDN (hereinafter referred to as TDN TSP) for teleconference services handled by the TSP 106. Participants for the teleconference call TDN TSP at the scheduled time to join the teleconference. In some cases, the TSP 106 may be able to handle several different teleconferences simultaneously and the same dedicated telephone number, TDN TSP, may be used by participants to several different teleconferences to access the teleconference services provided by the TSP 106. In such cases, participants to a particular teleconference may be provided with one or more teleconference participation identifiers (hereinafter referred to as TPIs) for the particular teleconference. A TPI may comprise an identifier (hereinafter referred to as teleconference identifier (TID)) which identifies the particular teleconference. The TID may, for example, be in the form of a Personal Identification Number (PIN) for that teleconference. The TID enables the TSP 106 to identify uniquely the particular teleconference that a participant wishes to join amongst the various teleconferences handled by the TSP 106.

The joining instructions may alternatively or additionally include one or more identifiers associated with particular participants to a teleconference (hereinafter referred to as participant identifiers (PIDs)) for some or all of the participants. In some cases, different participants may have different roles, privileges and the like within the teleconference which can be recorded against PIDs.

Around the scheduled time for the teleconference, a party that wishes to join the teleconference calls the dedicated telephone number for the teleconference, which results the calling party establishing a telephony session in the form of a telephone call with the TSP 106. The TSP 106 identifies the Calling Line Identifier (CLI) associated with the calling party telephony device. During the telephone call, the calling party is prompted to provide a TPI, which may include a TID and/or a PID, to the TSP 106 so that the TSP 106 can identify the correct teleconference for the calling party.

The TSP 106 may comprise Interactive Voice Response (IVR) menu capabilities that allow the TSP 106 to interact with the calling party and receive the TPI. For example, the IVR menu may comprise a set of pre-recorded messages that prompt the participant to enter the TID and/or their PID. An example of such a pre-recorded message could be: “please enter the conference identifier for the conference that you wish to join”. The participant may enter a TID via a suitable input mechanism (for example a keyboard or keypad, a touch-sensitive interface or the like) on their telephony device, which is then transmitted to the TSP 106, for example over a voice channel established between the telephony device and the TSP 106. The IVR may also prompt the participant to record a brief announcement message (for example their name) that is announced to other participants when they join the teleconference. The IVR may provide other options to the calling party.

In an IP Multimedia Subsystem (IMS) environment, the TSP 106 may comprise an IMS teleconference server. The IMS teleconference server may comprise two logical entities. One of the logical entities is responsible for processing signalling messages and can be considered to be a combination of an Application Server (AS) and a Media Resource Function Controller (MRFC). The other of the logical entities is responsible for processing media information, such as audio and video data, and can be considered to be a Media Resource Function processor (MRFP).

In such cases, the IMS teleconference server is assigned a Conference Factory URI which is used to access the teleconferencing services provided by the IMS teleconference server. An initiating User Equipment (UE), for example a mobile telephone, can initiate an ad hoc teleconference by transmitting a SIP INVITE message with the request URI set to the Conference Factory URI of the IMS teleconference server. When the IMS teleconference server receives the SIP INVITE message from the initiating UE, it allocates a Conference URI for the teleconference and responds to the initiating UE with a SIP 200 OK response message that includes the Conference URI. In some cases, the initiating UE may request a particular Conference URI for the teleconference. As such, the Conference Factory URI is used to obtain the Conference URI, which is then used to identify the particular teleconference initiated by the initiating UE.

Another UE can join the teleconference by sending a SIP INVITE message to the Conference URI. The other UE can determine the Conference URI in various ways. For example, the party associated with the initiating UE can provide the Conference URI to the other party in an e-mail, in a telephone call or the like, by sending a SIP REFER message to the other party so that the other party sends the SIP INVITE message to the IMS teleconference server, or by sending a SIP REFER message to the IMS teleconference server which then sends a SIP INVITE message to the other participant.

Subscribers to telecommunications networks other than an IMS network may still be able to use IMS teleconference services. For example, a POTS C in the PSTN 110 may be able to participate in IMS conferencing through a Media Gateway Controller Function (MGCF) which can act as a participant in the IMS teleconference on behalf of POTS C. The MGCF can then exchange SIP messages with the IMS conferencing server.

Although, in FIG. 1, the TSP 106 and the CSSP 107 are shown as separate entities, it will be appreciated that they could be implemented as a single entity in the telecommunications network 100.

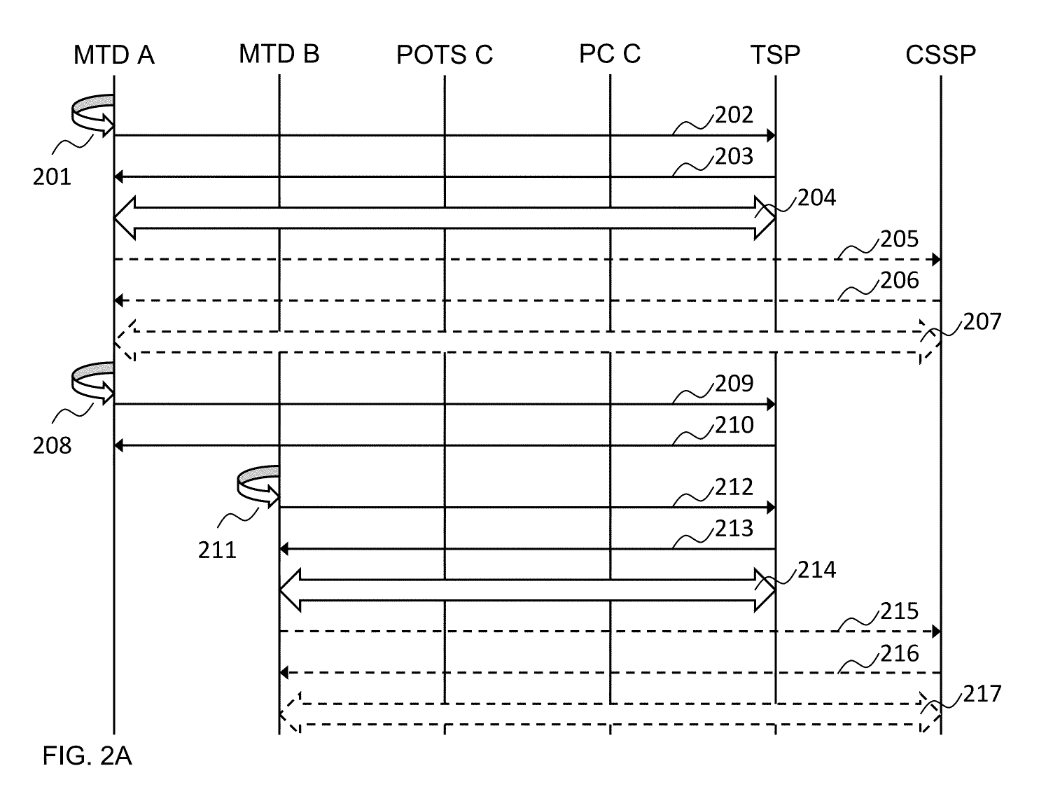

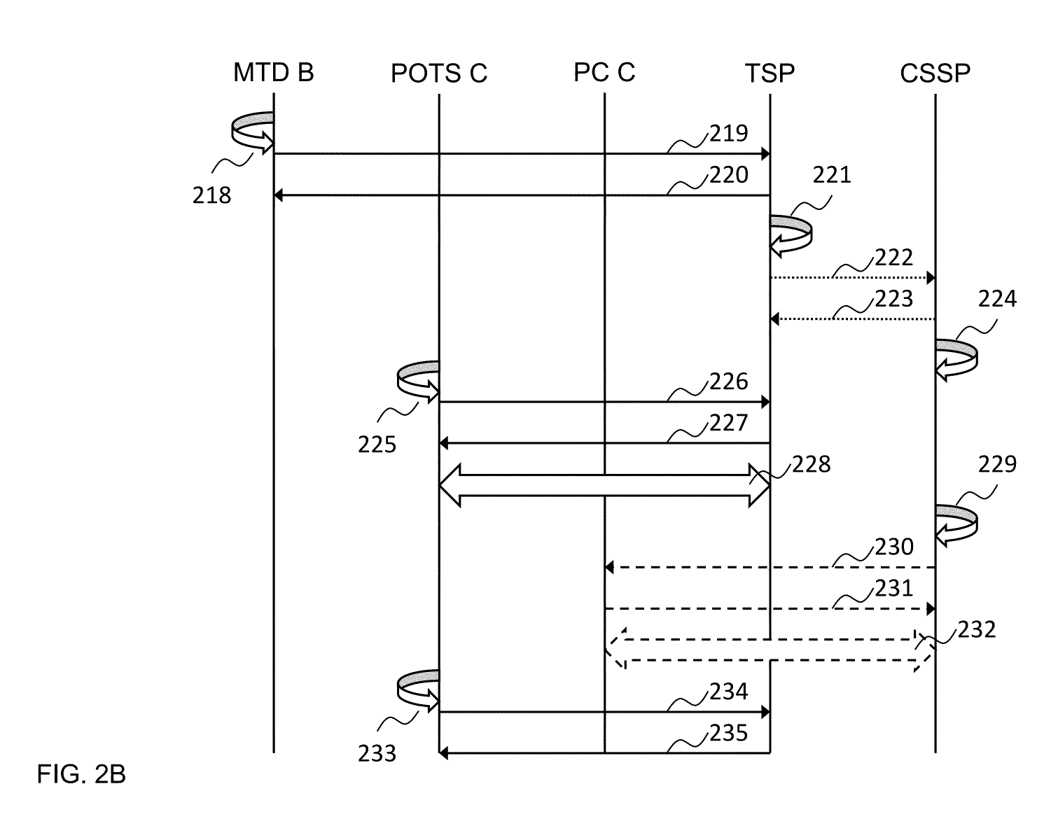

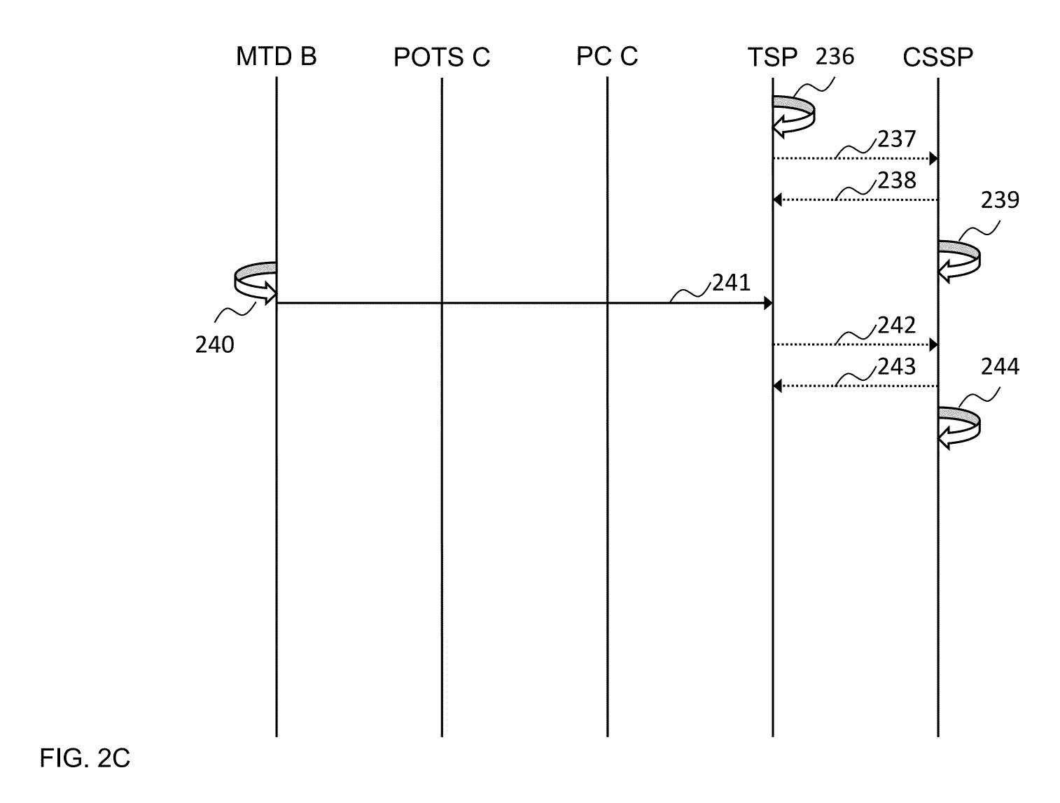

FIG. 2 is a flow diagram showing a method of processing data according to some embodiments, for example implemented in the telecommunications system 100 depicted in FIG. 1.

In this and subsequent flow diagrams, solid arrows denote transfer of signalling and/or media data between MTD A, MTD B or POTS C and the TSP 106. Dashed arrows denote transfer of signalling and/or media data between MTD A, MTD B or PC C and the CSSP 107. Dotted arrows denote transfer of signalling and/or media data between the TSP 106 and the CSSP 107.

Processing begins at step 201, when user A associated with MTD A initiates a call to the TSP 106 by entering the TDN, TDN TSP, for the TSP 106. This causes a call setup request, which includes a calling party identifier, TDN A, and a called party identifier, TDN TSP, to be transmitted into the network 101 towards the TSP 106 at step 202. The TSP 106 receives and accepts the call setup request from MTD A and responds, at step 203, with an appropriate answer message. A telephony session is established between MTD A and the TSP at item 204. The telephony session will typically be a circuit-switched voice call, the set-up and control for which is known in the art.

Application software running on MTD A detects that the telephony session has been established between MTD A and the TSP 106 and notifies, at step 205, the CSSP 107 of the TDNs, in this case TDN A and TDN TSP, of the parties involved in the telephony session. The CSSP 107 acknowledges receipt of the notification from MTD A at step 206 and establishes a data communications session separate from the telephony session for the communication of data between MTD A and CSSP 107 at item 207. The data communications session is established with MTD A as a client and the CSSP 107 as a server.

The data communication session could be a HyperText Transfer Protocol (HTTP) or HyperText Transfer Protocol Secure (HTTPS) session. The CSSP 107 updates a record for MTD A to indicate that the communications session has been established.

The separate data communications session is established whilst the telephony session between MTD A and the TSP 106 is still in progress, and is continued in parallel with the telephony session, such that voice call data is transmitted via the telephony session and other data may be transmitted via the data communications session, after the establishment of the separate data communications session.

The TSP 106 prompts user A via the telephony session of item 204 to enter a TPI for the teleconference that they wish to join. User A enters a TID (hereinafter TID A) at MTD A at step 208 and TID A is transmitted to the TSP 106 via the telephony session at step 209. The TSP 107 acknowledges receipt of TID A from MTD At step 210.

Steps 211 to 220 correspond to steps 201 to 210 respectively but involve user B and MTD B instead of user A and MTD B. In particular, user B transmits a TID for the teleconference that they wish to join, which is hereinafter referred to as TID B.

At step 221, the TSP 106 compares TID A it received from MTD A at step 209 with TID B it received from MTD B at step 219 and determines that both relate to the same teleconference and, therefore, that MTD A and MTD B are participants for the same teleconference. The TSP bridges the two telephony sessions it established with MTD A and MTD B to enable user A and user B to communicate with each other via the TSP 106.

At step 222, the TSP transmits correlation data to the CSSP 107, identifying that MTD A and MTD B are participants in the same teleconference. The correlation data comprises TDN A and TDN B. The correlation data may comprise TID A and/or TID B and/or another TID associated with the teleconference in which MTD A and MTD B are participants.

The CSSP 107 acknowledges receipt of the correlation data at step 223.

At step 224, the CSSP 107 assesses the correlation data and identifies that MTD A and MTD B are both participants in the same teleconference. The CSSP 107 also determines that it has already established data communications sessions with MTD A and MTD B. The CSSP 107 joins the two communication sessions together to create a channel between MTD A and MTD B through which data can be communicated in either direction.

At step 225, user C associated with POTS C initiates a call to the TSP 106. This causes a call setup request, which includes TDN C and TDN TSP, to be transmitted into the network 101 towards the TSP 106 at step 226. The TSP 106 receives and accepts the incoming call setup request from POTS C and responds, at step 227, with an appropriate answer message. A telephony session is established between POTS C and the TSP 106 at item 228.

In this case, the SSP in the PSTN 110 receives in-call signalling information for the call, including TDN C, for which an AIN call origination trigger is configured. This triggers notification of call party details for the call, including TDN C and TDN TSP, to the CSSP 107 (not shown).

At step 229, the CSSP 107 retrieves a record for user C in which TDN C is stored against IP C. At step 230, the CSSP 107 transmits a request to establish a data communications session with PC C using IP C. The step 231, PC C transmits a response message (possibly following interaction with user C) indicating that the data communications session should be established. The data communications session is established between PC C and the CSSP 107 at item 232.

Steps 233 to 235 correspond to steps 208 to 210 and 218 to 220, except they involve user C and POTS C instead of user A and MTD A, and user B and MTD B respectively. In particular, user C transmits a TID to the TSP 106 for the teleconference that they wish to join via POTS C, which is hereinafter referred to as TID C.

At step 236, the TSP 106 compares TID C it received from POTS C at step 234 with the TIDs A and B and determines that MTD A and B and POTS C are participants for the same teleconference. The TSP 106 joins the telephony session it established with POTS C with the bridged telephony sessions it established between telephony devices A and B to provide a multi-party teleconference by means of which users A, B and C can communicate with each other via MTD A, MTD B and POTS C respectively.

At step 237, the TSP 106 transmits correlation data to the CSSP 107, identifying that POTS C has joined the teleconference in which MTD A and B are participants. The correlation data includes TDN C associated with POTS C and may comprise TDN A and/or TDN B, TID A and/or TID B and/or another TID associated with the teleconference in which MTD A and MTD B are participants. The CSSP 107 acknowledges receipt of the correlation data at step 238.

At step 239, the CSSP 107 assesses the correlation data and identifies that POTS C, MTD A and MTD B are all participants in the same teleconference.

The CSSP 107 determines that a data communications session has not already been established with POTS C, but that a data communications session has already been established with PC C, both of which are associated with user C. The CSSP 107 joins the data communication session between MTD A and B together with the communication session it has established with PC C to create a multi-party data communications channel by means of which user A, user B and user C can communicate data via MTD A, MTD B and PC C respectively.

If, for example, user A wants to communicate data to (e.g. share data with) user C, it transmits the data to the CSSP 317. The CSSP 317 performs a lookup in a record for user A using TDN A for MTD A and identifies that a communications session has been established between MTD A and PC C (as well as with MTD B). The CSSP 317 retrieves IP C for PC C and transmits the data received from MTD A to PC C using the retrieved IP C.

At some later stage, at step 240, one of the users, in this example user B, decides to leave the teleconference. Via suitable user action at MTD B, an appropriate message is transmitted, at step 241, towards the TSP 106 to terminate participation of MTD B in the teleconference.

At step 242, the TSP 106 transmits an appropriate message to the CSSP 107 to inform the CSSP 107 that MTD B is no longer a participant in the particular teleconference. The CSSP 107 acknowledges receipt of the message of step 242 at step 243.

At step 244, the CSSP 107 determines that MTD B is no longer a participant in the teleconference in which MTD A and POTS C are participants. The CSSP 107 removes MTD B from the multi-party data communications session involving MTD A and PC C. The CSSP 107 may maintain the data communications session it had previously established with MTD B or may terminate the data communications session.

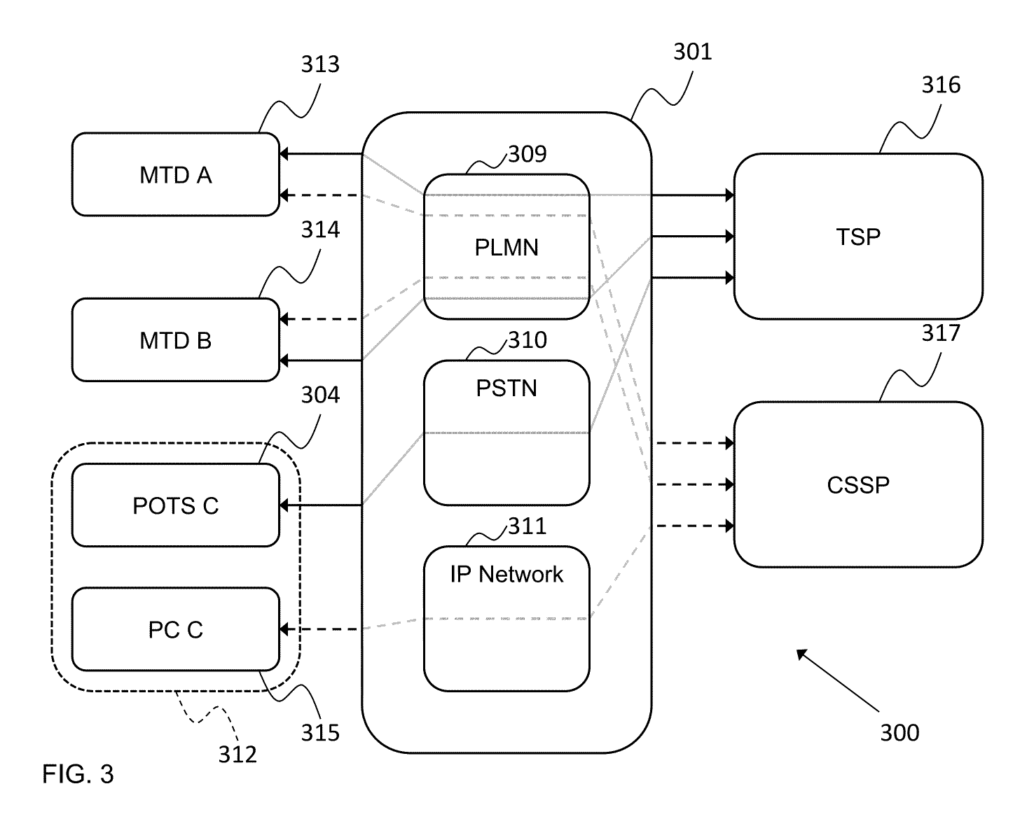

FIG. 3 is a schematic block diagram showing a telecommunications system 300 according to some embodiments. The telecommunications system 300 is similar to the telecommunications system 100 described above with reference to FIG. 1 in the sense that it includes some of the same or similar network elements to the telecommunications system 100 depicted in FIG. 1. Similar elements are shown in FIG. 3 with the same reference numerals as those used in FIG. 1 incremented by 200.

In particular, the telecommunications system 300 includes a telecommunications network 301, comprising a PLMN part 309, a PSTN part 310 and an IP network part 311.

Similarly to some embodiments described above with reference to FIG. 1, users A and B are associated with respective mobile telephony devices 313 and 314, and user C is associated with a POTS telephone 304 and a PC 315. In these embodiments, POTS telephone 304 is the same as POTS telephone 104 and is likewise referred to herein as POTS C. MTDs 313 and 314 and PC 315 are similar to MTDs 102 and 103 and PC 105 respectively. However, MTDs 313 and 314 and PC 315 include additional functionality described below. For convenience, MTD 313 is referred to herein as MTD A, MTD 314 is referred to herein as MTD B and PC 315 is referred to herein as PC C.

Similarly to some embodiments described above with reference to FIG. 1, the telecommunications network 300 includes a TSP 316 and a CSSP 317. However, in these embodiments, TSP 316 does not communicate with CSSP 317.

In these embodiments, TSP 316 correlates TPIs to identify participants for the same teleconference and joins those participants into the same teleconference, but does not provide correlation data to the CSSP 317 to enable to CSSP 317 to determine participants for a particular teleconference. In these embodiments, the CSSP 317 separately receives TPIs, correlates them, identifies participants for the same teleconference and establishes a multi-party data communications session with the participants.

Although, in FIG. 3, the TSP 316 and the CSSP 317 are shown as separate entities, it will be appreciated that they could be implemented as a single entity in the telecommunications network 300.

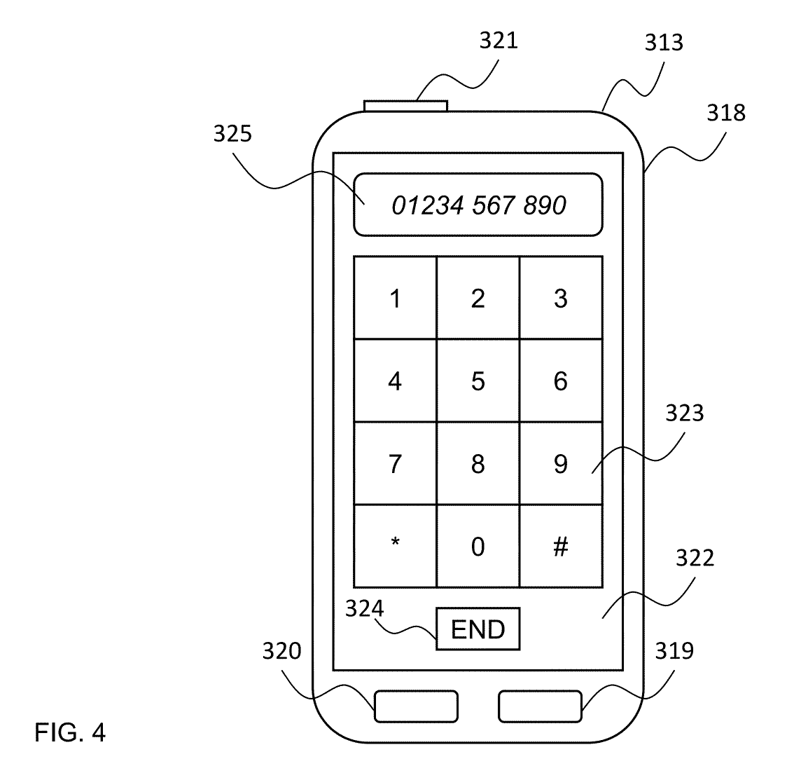

FIG. 4 shows a front view of a mobile telephony device according to some embodiments. For ease of explanation, the mobile telephony device corresponds to mobile telephony device 313 shown in FIG. 3.

The mobile telephony device 313 comprises memory storage and one or more processors (not shown) for data processing purposes including implementation of an operating system, for example an Android™, Symbian™, Blackberry™ or Windows Phone™ operating system. The operating system provides a platform for execution of application software (or ‘applications’ or ‘apps’) for allowing a user to perform different tasks on the mobile telephony device 313. The application software may be installed during manufacture or may be downloaded and installed by a user of the mobile telephony device 313.

The mobile telephony device 313 comprises a body 318, hard-wired input keys 319, 320 and a power on/off button 321. The mobile telephony device 313 comprises a touch-screen user interface 322 which is operable to output a graphics display and receive input via user touches on the interface 322. The hard-wired input keys 319, 320 may be operable to execute common operations such as ‘Open menu’, ‘Go to home screen’, ‘Go back to last screen’, etc. Alternatively or additionally, one or more hard-wired input keys 319, 320 may be implemented as soft keys on the touch-screen 322.

The mobile telephony device 313 supports a variety of different communication methods including telephony functionality enabling a user to conduct incoming and outgoing telephone calls with one or more remote entities, such as TSP 316, and data transfer functionality enabling a user to conduct incoming and outgoing data transfer with one or more remote entities, such as CSSP 317, in the telecommunications network 300.

The mobile telephony device 313 comprises a number of components (not shown) which are known in the art, the operation of which is not described here in detail, including one or more radio frequency transceiver(s) and aerial(s), a speech coder/decoder connected to a loudspeaker and a microphone, and, in some embodiments, a removable Subscriber Identity Module (SIM) connected via electrical contacts.

The user of the mobile telephony device 313 is currently conducting a call with a remote party, in this example the TSP 316, so an in-call screen application is running on mobile telephony device 313. The in-call screen application is displaying an in-call screen on the touch-screen user interface 322. The in-call screen displayed on the touch-screen user interface 322 includes a number of soft-keys (generally designated 323) which are responsive to user touches to provide input to the in-call screen application running on mobile telephony device 313. The soft-keys 323 include dial-pad digits 1, 2, . . . to 0 and the * (‘star’) and # (‘hash’) symbols which are used for entering telephone dialing numbers. The soft-keys 323 may also include several other soft-keys, which are operable to initiate other in-call functionality in response to user input, for example call-hold, mute, speaker-phone, and show/hide dial-pad operations. In this example, the soft-keys 323 include a soft-key 324 which, in response to a user pressing it, triggers termination of a pending telephone call.

The telephone dialing number 325 (in this example the number ‘01234 567 890’ which is a telephone dialing number, TDN TSP, associated with the TSP 316) of the remote party to the call is displayed towards the top of the displayed in-call screen.

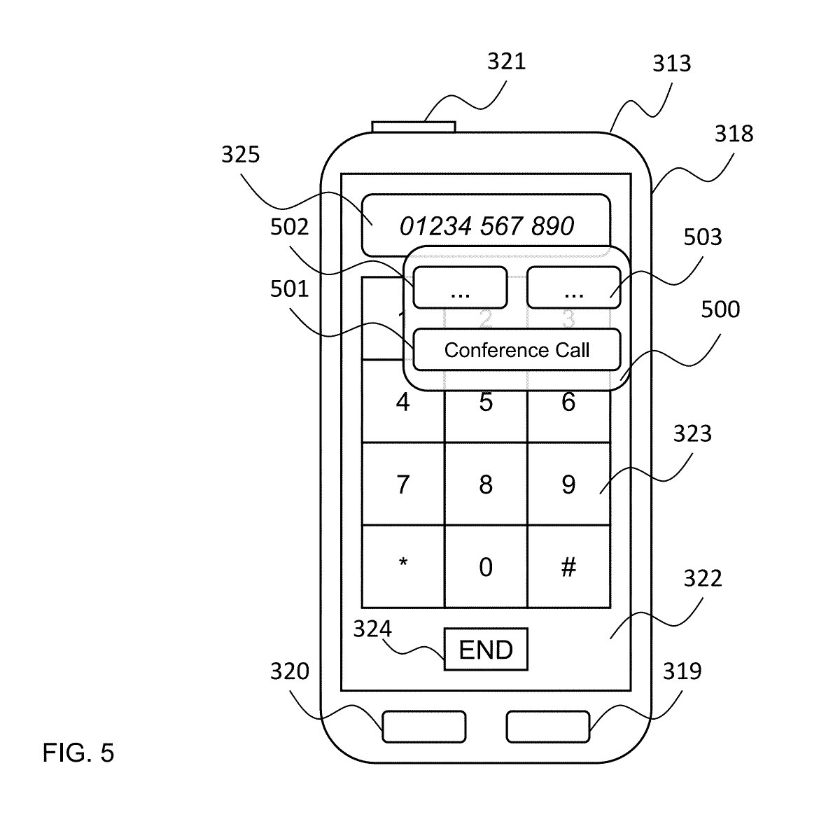

FIG. 5 shows a front view of mobile telephony device 313 according to some embodiments. In these embodiments, application software running on the mobile telephony device 313 monitors the status of one or more applications on mobile telephony device 313 which have access to the touch-screen user interface 322 (for example are able to send requests (or ‘calls’) to an API associated with the touch-screen user interface 322). In this example, the monitored applications include the exemplary predetermined in-call screen application described above in relation to FIG. 4, but the monitored application could be any other application on mobile telephony device 313.

In response to the monitoring indicating that the predetermined in-call screen application is displaying (for example in the foreground) a screen on the touch-screen user interface 322, an overlay portion 500 is displayed over a part of the screen displayed by the monitored application.

The monitoring of the application(s) could comprise monitoring system events in the operating system of the mobile telephony device 313. When a given system event occurs, the status of one or more monitored applications having access to the touch-screen user interface 322 could change, thus triggering configuration of the overlay portion 500. The monitoring could comprise monitoring a list of tasks or processes running on the mobile telephony device 313. Configuring of the overlay portion 500 could be triggered by the predetermined application being at the top of a list of all tasks or processes running on the mobile telephony device 313, or top of a list of tasks which involve or are related to screen display via the touch-screen user interface 322 of the mobile telephony device 313.

As shown in FIG. 5, the overlay portion 500 is visible above the screen displayed by the in-call screen application. In these embodiments, the overlay portion 500 comprises a translucent layer such that the part of the screen below the overlay portion 500 is partially visible through overlay portion 500. In this case, the soft-keys for digits ‘2’ and ‘3’ on the dial-pad part of the in-call screen can be seen through the translucent overlay portion 500.

The overlay portion 500 comprises several touch-sensitive screen regions 501, 502, 503 which are operable to initiate one or more operations of the application software independently of the predetermined application in response to user input via the touch-sensitive screen regions 501, 502, 503. User input via any of touch-sensitive screen regions 501, 502, 503 is passed to the application software rather than to the predetermined in-call screen application displaying the in-call screen below the overlay portion. For example, pressing touch-sensitive screen region 503 will not provide a user input of the dial-pad digit ‘3’ to the in-call screen application, but rather will be passed to the application software for processing.

In this example, touch-sensitive screen region 501 displays text such as “Conference Call” to indicate that is has functionality associated with conference calls. Touch sensitive regions 502 and 503 could display graphical content, such as textual content, an icon or the like, to indicate their functionality.

During a call, the user can press the touch-sensitive screen region 501 to indicate that they are currently involved in a teleconference. The user input via the touch-sensitive screen region 501 is then passed to the application software rather than to the predetermined in-call screen application for processing.

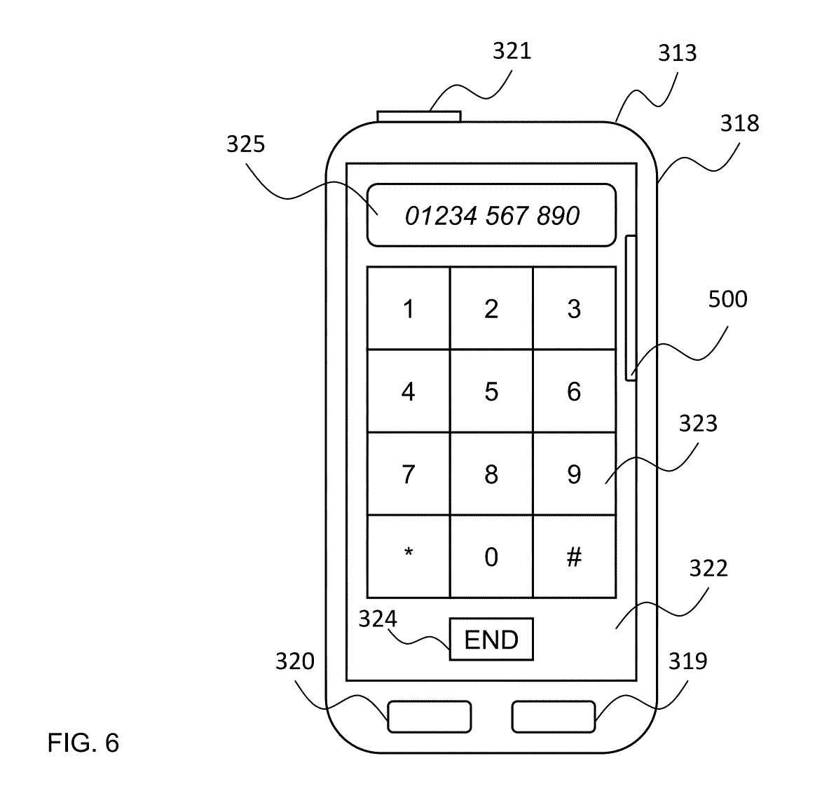

FIG. 6 shows a front view of mobile telephony device 313 according to some embodiments.

In FIG. 6, the user has pressed the touch-sensitive screen region 501 described above in relation to FIG. 5 to indicate that they are currently a participant in a teleconference. In these embodiments, the pressing of touch-sensitive region 501 causes the display portion 500 to retract towards the edge of the touch-screen user interface 322 so that the user can interact with the monitored application, which in this case is displaying the in-call screen in the touch-sensitive user interface 322.

When the user of the mobile telephony device 313 interacts with the touch-screen user interface 322 outside of the bounds of the retracted overlay portion 500, such user input is allowed to pass to the monitored application.

During the pending telephone call to the TSP 316, the user is prompted to enter a TPI, such as a TID and/or a PID. When prompted, the user inputs the TPI via the dial-pad digits. The TPI is then provided to the TSP 316 over a voice channel between the mobile telephony device 317 and the TSP 316 as described above. For example, input via the dial-pad digits may cause a multi-frequency tone sequence (such as a Dual-tone Multi-Frequency (DTMF) sequence) to be transmitted to the TSP 316 via the voice channel.

In this case, the application software running on the mobile telephony device 313 is configured to capture the user input. The application software may, in some cases, be able to collect the multi-frequency tones generated by the user input, interpret the collected multi-frequency tones and determine the TPI entered by the user from the captured multi-frequency tones. The application software then provides the TPI to the CSSP 317 via a data communications session so that the CSSP 317 can identify a teleconference in which the mobile telephony device 313 is a participant and establish a multi-party data communications session with other participants in the same teleconference.

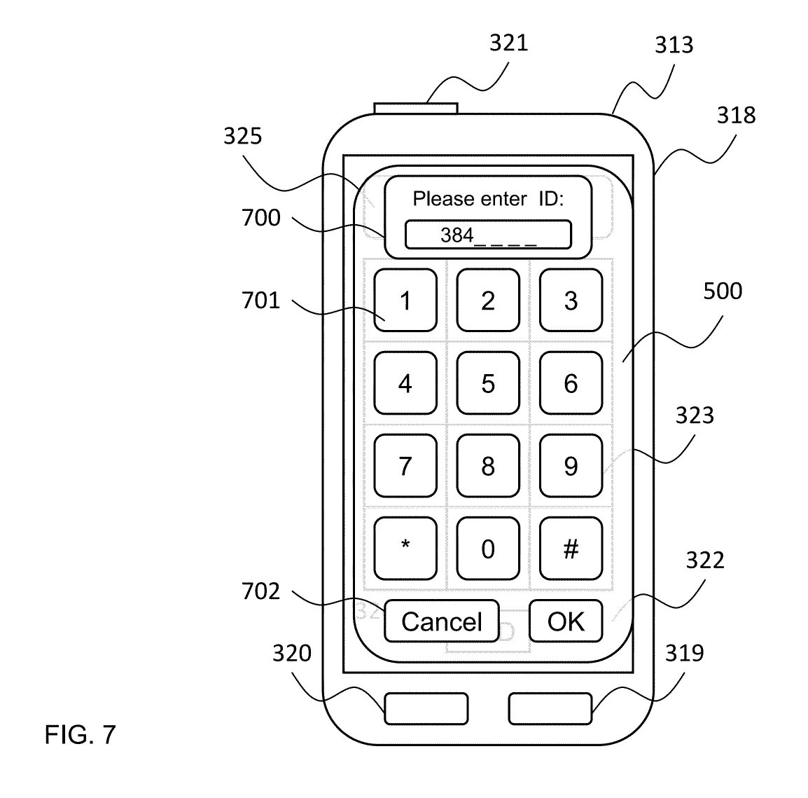

FIG. 7 shows a front view of mobile telephony device 313 according to some embodiments.

In FIG. 7, the user has pressed the touch-sensitive screen region 501 described above in relation to FIG. 5 to indicate that they are currently a participant in a teleconference. In these embodiments, instead of causing the display portion 500 to retract, the pressing of touch-sensitive region 501 causes the display portion 500 to expand to occupy an area of the touch-sensitive display screen 322 that covers the dial-pad keys of the in-call screen displayed by the monitored application. At this stage, the user had not yet provided the TID to the TSP 316 via the in-call screen displayed by the monitored application.

The display portion 500 includes a dialogue box region 700 which includes text that prompts the user to enter the TID for the teleconference that they wish to join. The display portion also 500 includes a touch-sensitive region, generally designated 701, with dial-pad keys which correspond to the dial-pad keys of the in-call screen. The display portion 500 also includes two touch-sensitive screen regions, collectively designated 702. One of the touch-sensitive screen regions 702 displays the text “Cancel” and can be pressed to cancel entry of the TID. The other touch-sensitive screen region 702 displays the text “OK” and can be used to confirm that the correct TID has been entered. The display portion 500 may include additional and/or alternative touch-sensitive screen regions and/or display different graphical content in any one or more of the touch-sensitive screen regions.

User input via any of touch-sensitive screen regions 701, 702 within the boundary of the display portion 500 is passed to the application software rather than to the monitored application. For example, pressing the “3” key in the touch-sensitive screen region 701 will provide a corresponding input to the application software; not a user input of the dial-pad digit ‘3’ to the monitored application.

Once the user has correctly entered the TID for the conference that they wish to join, they press the touch-sensitive screen region 702 having the “OK” functionality. The TID is then transmitted to the CSSP 317 as explained above.

The application software may be configured to prompt the user for entry of a PID, by displaying alternative text in the dialogue box 700. The user then enters the requested PID via the dial-pad keys and, once it is entered correctly, presses the “OK” key to trigger transmission of the PID to the CSSP 317.

The application software is configured to pass the user input to the monitored application so that the monitored application can provide the TPI to the TSP 316 in a manner described above. For example, the application software may be configured to cause the monitored application to generate a multi-frequency tone sequence corresponding to the captured TPI so that the TPI can be provided to the TSP 316.

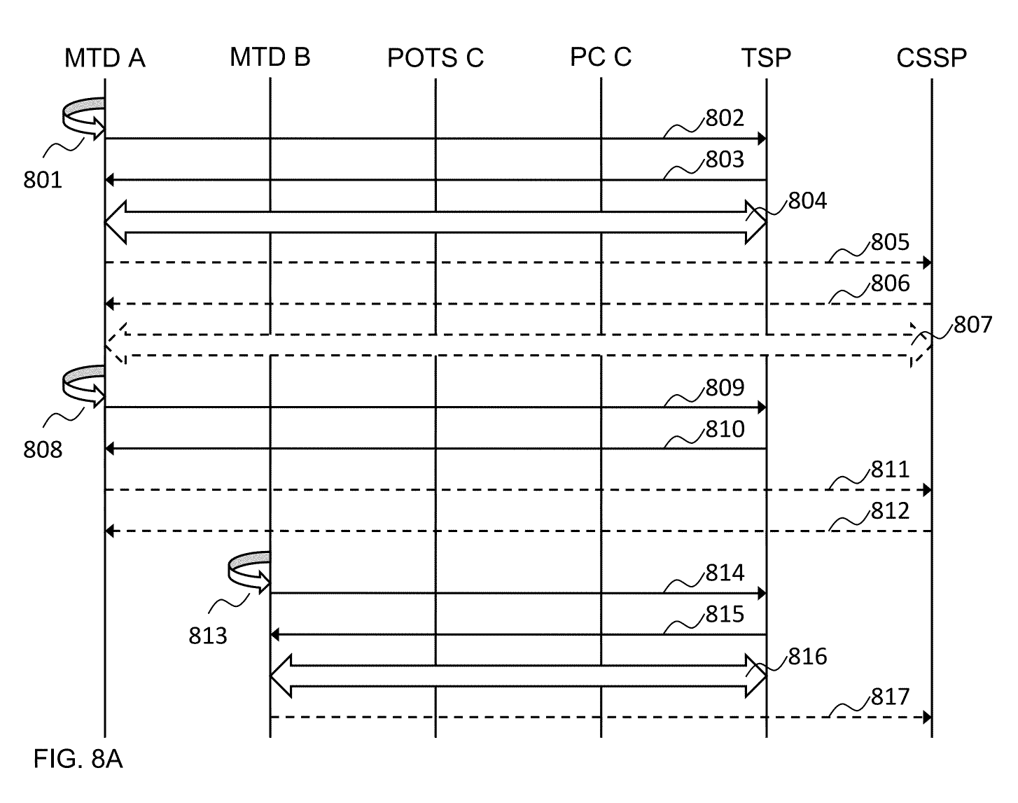

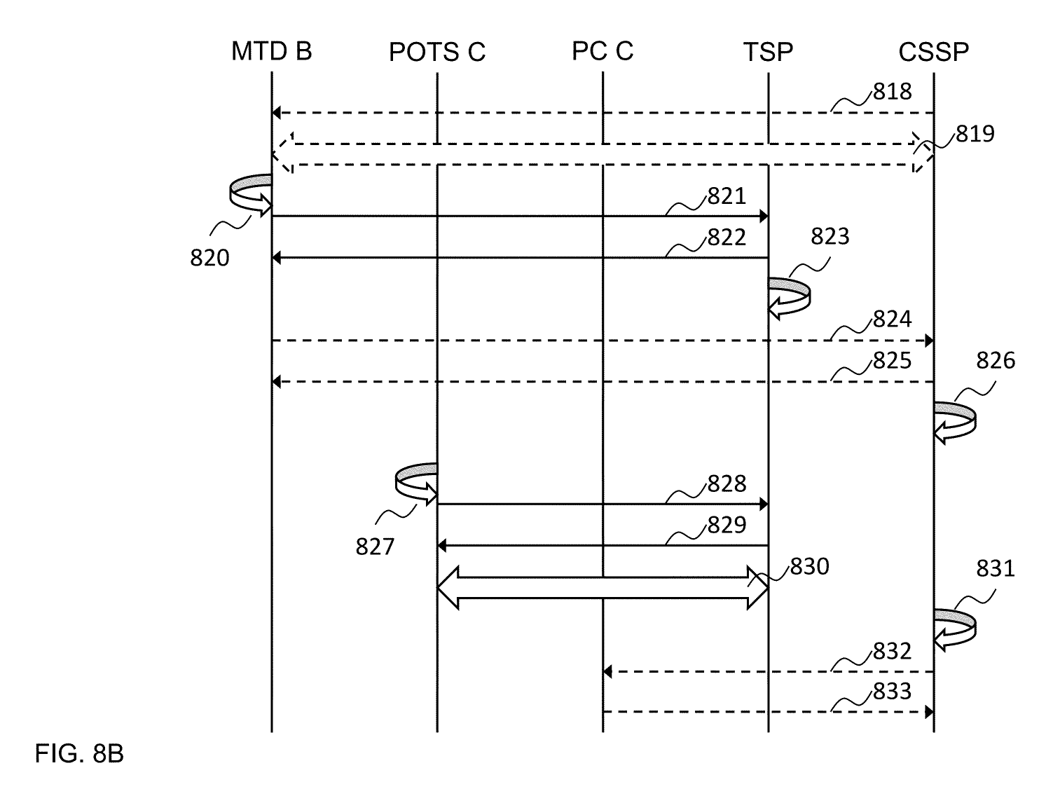

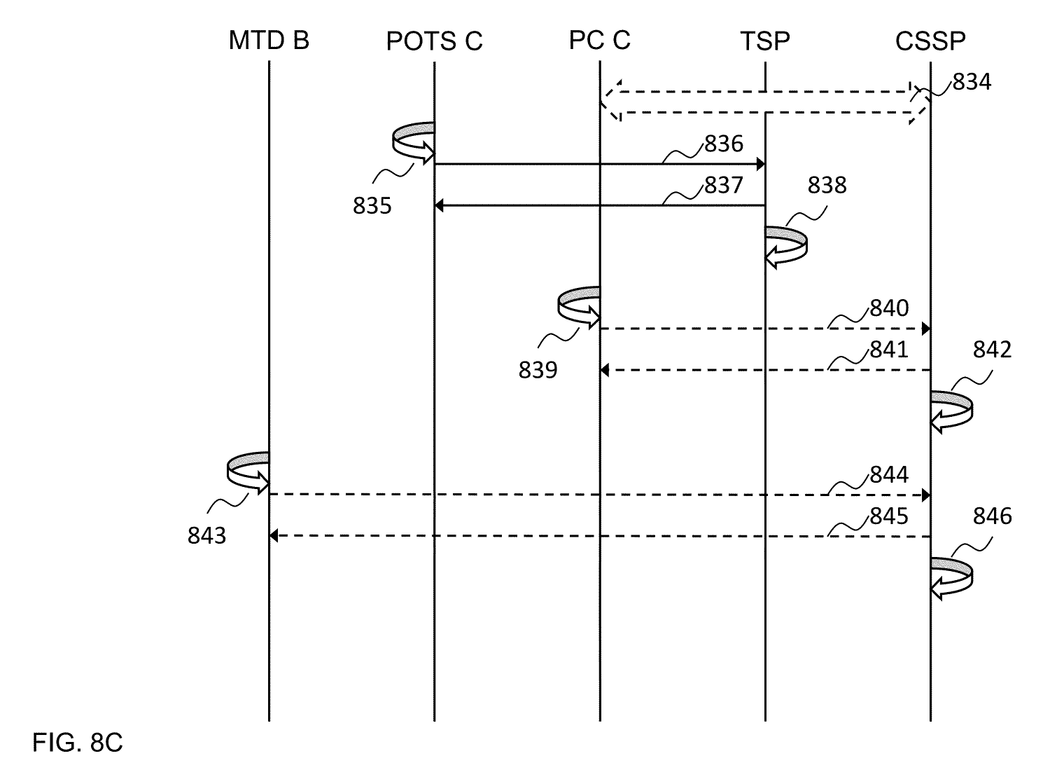

In some embodiments, the application software may not be configured to capture user input to the monitored application, as described above with reference to FIG. 7, and/or may not be configured to pass user input via the display portion 500 to the monitored application, as described above with reference to FIG. 8. In such embodiments, the user is first prompted to enter the TPI for the teleconference into the in-call screen application which causes the TPI to be transmitted to the TSP 316. Then, the user presses the “Conference Call” key 501 described above with reference to FIG. 5, and enters the TPI via the dial-pad keys of the display portion 500 which causes the TPI to be transmitted to the CSSP 317. Such embodiments facilitate the possibility of entering different TPIs for the TSP 316 and the CSSP 317.

FIG. 8 is a flow diagram showing a method of processing data according to some embodiments, for example implemented in the telecommunications system 300 depicted in FIG. 3.

Steps 801 to 807 are similar to steps 201 to 207 described above in relation to FIG. 2. In particular, the TSP 316 prompts user A to enter the TID via MTD A.

At step 808, user A enters the TID via MTD A. In some cases, user A may enter the TID via the in-call screen application running on MTD A which causes multi-frequency information to be sent to the TSP 316 via the telephony session of step 404. The TID is captured by application software running on MTD A. In other cases, user A may enter the TID via the application software running on MTD A which captures the TID and passes any user input entered via the application software to the in-call screen application so that the TID can also be transmitted to the TSP 316.

At step 809, MTD A transmits the TID entered at step 808 to the TSP 316 and receives an appropriate acknowledgement from the TSP 316 at step 810. At step 811, MTD A transmits the captured TID entered at step 808 to the CSSP 317 and receives an appropriate acknowledgement from the CSSP 317 at step 812.

Steps 813 to 822 and steps 824 and 825 are similar to steps 801 to 812 respectively but involve user B and MTD B instead of user A and MTD A. In particular, user B transmits a TID (hereinafter TID B) for the teleconference that they wish to join to both the TSP 316 (at step 821) and to the CSSP 317 (at step 824).

Step 823 is similar to step 221 described above in relation to FIG. 2, in that the TSP 316 compares TID A it received from MTD A at step 809 with TID B it received from MTD B at step 821 and determines that both relate to the same teleconference and that MTD A and MTD B are participants in the same teleconference. The TSP 316 bridges the two telephony sessions it established with MTD A and MTD B to enable audio to be transmitted between MTD A and MTD B.

In this case, TSP 316 does not communicate with CSSP 317 and, therefore, does not transmit correlation data to CSSP 317.

Instead, at step 826 the CSSP 317 compares TID A that it received from MTD A at step 811 and TID B that it received from MTD B at step 824 and determines that MTD A and MTD B are participants in the same teleconference. The CSSP 317 determines, from a record, that it has already established data communications sessions with MTD A and MTD B (at items 807 and 819). The CSSP 107 joins the two communication sessions together to create a channel between MTD A and MTD B through which data can be communicated in either direction.

The processing of step 826 differs from that of step 221 described above in relation to FIG. 2 in that, in the method described with reference to FIG. 8, the CSSP 317 does not receive correlation data from the TSP 316. Instead, it receives TIDs from MTD A and MTD B, correlates the TIDs and determines that MTD A and MTD B are both participants in the same teleconference. Accordingly, it creates a data channel between MTD A and MTD B for the communication of data between MTD A and MTD B.

Steps 827 to 837 are similar to steps 225 to 235 respectively described above in relation to FIG. 2.

Step 838 is similar to step 236 described above in relation to FIG. 2, in that the TSP 316 receives TID C from user C via POTS C, determines that POTS C is a participant for the teleconference in which MTD A and MTD B are participants and joins POTS C into the teleconference with MTD A and MTD B. However, since TSP 316 does not communicate with CSSP 317, it does not transmit correlation data to CSSP 317.

At step 839, user C enters TID C at PC C. At step 839, PC C transmits TID C to the CSSP 317 via the data communications session established between PC C and CSSP 317 at step 834. At step 841, the CSSP 317 acknowledges receipt of TID C to user C at PC C.

At step 842, CSSP 317 determines that user C associated with PC C is a participant for the teleconference in which MTD A and MTD B (and POTS C) are participants and creates a channel for the communication of data between MTD A, MTD B and PC C.

Some time later at step 843, user B decides to leave the teleconference and takes an appropriate action at MTD B, for example by pressing an “END” soft-key. Application software running on MTD B detects the termination of the telephony session with the TSP 316 and, at step 844, transmits an appropriate message to inform the CSSP 317 accordingly. At step 845, the CSSP 317 acknowledges receipt of the message of step 844.

At step 846, the CSSP 317 determines that MTD B is no longer a participant in the teleconference and may remove MTD B from the multi-party data communications session.

The above embodiments are to be understood as illustrative examples of the invention. Further embodiments of the invention are envisaged.

For example, in some embodiments described above, a participant for a teleconference provides a teleconference participation identifier to the TSP 106 which enables the TSP 106 to identify the teleconference that the participant wishes to join. In some cases, the teleconference participation identifier may comprise one or more TIDs and/or one or more PIDs. The teleconference participation identifier could, alternatively or additionally, comprise a telephony party identifier (for example a TDN) associated with the participant that is pre-registered against a particular teleconference (for example by a party that requests setup of the teleconference). In such cases, the TSP 106 may identify the telephony party identifier in an incoming request to join the teleconference and determine the teleconference in which the participant wishes to participate based on the telephony party identifier.

As described above, a translucent overlay 500 may be displayed over a part of the screen displayed by the predetermined application. In some embodiments, an overlay comprising a mixture of transparent, translucent and/or opaque parts could be displayed. In some embodiments, the overlay could be displayed over the entire screen, rather than just a part of the screen.

In some embodiments described above, a user presses a “Conference Call” key 501 to cause the application software to provide a mechanism for entry of the TPI, which is then transmitted to the CSSP 317. In other embodiments, the CSSP 317 receives call party details from a telephony device that calls the TSP 316, which call party details include a TDN associated with the telephony device and a TDN, TDN TSP, associated with the TSP 316. The CSSP 317 may recognise TDN TSP as a TDN associated with a teleconference service provider, for example by way of a look-up into a database of known TNDs for teleconference service providers, and transmit a command to the telephony device to provide the mechanism for entry of the TPI without the user having to press the conference call button 501. This may reduce the number of user inputs to obtain the TPI.

In some embodiments described above, a user of a telephony device that wishes to participate in a teleconference dials a TDN, TDN TSP, associated with the TSP 106, 316 to initiate a telephone call to the TSP 106, 316. In some embodiments, the TSP 106, 316 may be able to perform out-dial to a given telephony device. Such out-dial may, for example, be as a result of a participant in the teleconference wishing to add a previously uninvited party to participate in the teleconference, the participant entering a special code sequence which is transmitted to the TSP 106, 316 (for example “*1”) and then the TDN of a telephony device associated with the previously uninvited party. This results in the TSP 106, 316 transmitting a call setup request to the telephony device associated with the previously uninvited party, which, when answered, establishes a telephony session between the TSP 106, 316 and the telephony device associated with the previously uninvited party, which can be joined into a pending teleconference. In such cases, the uninvited party may not need to enter a TPI because the TSP 106, 316 may already be aware of the teleconference in which the previously uninvited party is to participate.

The embodiments described above primarily relate to telephony devices having associated identities in the form of telephone dialing numbers (TDNs). In other embodiments, one or more, or all of the identities could be non-telephone-dialing-numbers, for example usernames, email addresses etc. Where non-telephone-dialing-number identities are employed, mappings between non-telephone-dialing-number identities and telephone dialing number identities may be used by the CSSP 107, 317 for converting from non-telephone-dialing-number identities to telephone dialing numbers after receipt of the call party details

The personal computer PC C described above could alternatively be another device or combination of devices with corresponding data processing, display and data input capabilities, for example a television, a smart television, a general purpose desktop computer terminal, a general purpose laptop computer terminal, a general purpose tablet computer terminal, an in-car computing and communications system a satellite navigation system, games console, or any combination thereof.

In some embodiments described above, telephone calls to/from mobile telephones and a POTS phone are detected either by application software running on the mobile telephony devices or by a telephony apparatus configured accordingly. In alternative embodiments, during a voice call, a party to the call may uses a computing terminal, such as PC C, to enter in call party details (for example the calling and called party telephone dialing numbers) for the call via a web server interface. The web server interface passes the call party details to the CSSP 107, 317 which can then establish a communications session, separate to the voice call, on the basis of the calling and called party telephone dialing numbers received from the web server interface.

The logical coupling between user devices for a user may be temporary or more permanent. If for example a user has a POTS phone and a PC as their user devices in their home, then these devices will tend to be used by the user on a fairly permanent basis, so the logical coupling would tend to be more permanent. If, for example, a user has a mobile phone and a satellite navigation system in their car, then the logical coupling between the two devices may only be valid when the user is in or near their car, so the logical coupling would only be maintained temporarily when the two devices are within close enough proximity of each other.

The logical coupling between a user's devices can be activated (or otherwise triggered) by a variety of different processes. One example could involve communication between a smartphone and a satellite navigation system via a short wave radio interface (such as a Bluetooth™ interface) in order to couple the two devices together locally, along with subsequent registration of details of such with the CSSP 107, 317. Another example could be registration of device details via a website. A further example might involve registration by a service engineer when installing a telephone and set-top box combination. Alternatively, registration could be carried out over the telephone verbally to an administrative operator, or via an Interactive Voice Response (IVR) system.

The above embodiments of the invention describe telephone calls and establishment of communications sessions for user devices of three parties. All embodiments of the invention can be applied to user devices of multiple parties numbering more than three. When the multiple parties are conducting a multi-leg teleconference, a communications session can be created between all of their user devices, allowing communication of data, not just between three user devices, but between many different combinations of user devices, i.e. multi-branch data communication.

The connections between the CSSP 107, 317 and the mobile telephones and the PC are described above as being HTTP or HTTPS connections. In alternative embodiments, the connections could be peer-to-peer connections such that data is communicated between the mobile telephones and the PC through a number of peer-to-peer nodes. Creating the peer-to-peer connections may involve use of processes for traversing firewalls, for example using protocols such as the Simple Traversal of User Datagram Protocol (UDP) Through Network Address Translators (NATs) (STUN) protocol.

Further alternatively, the connections could initially be created as HTTP or HTTPS connections between the CSSP 107, 317 the mobile telephones and the PC, but then could be migrated to peer-to-peer connections according to network topography and/or current network load.

The exemplary embodiments described above in relation to FIGS. 4 to 7 include reconfiguration of a touch-screen user interface of a mobile telephony device 313. Embodiments of the invention could equally be applied to a mobile telephony device having a non-touch-sensitive screen, in which case the reconfiguration can involve reconfiguring one or more soft-keys accordingly.

In embodiments of the invention, at least one of the call parties may use a Voice-over-Internet-Protocol (VoIP) enabled device, and one, or each, party may be identified in the call setup procedures by means of a unique identifier other than a telephony dialing number, for example a Session Initiation Protocol (SIP) identifier, which can be transmitted to the CSSP 107, 317 as a call party identifier.

In embodiments of the invention, a call party identifier may take the form of an Internet Protocol (IP) address, which may be either a static or dynamically allocated IP address. This may for example be the IP address which a user device transmits to the CSSP 107, 317 in a client-server connection setup request, for example an HTTP setup request, when establishing a leg of the communications session. This may uniquely identify the call party associated with the device making the request. If for example, a given party sends the telephony dialing number of only the other party in a telephone call to the CSSP 107, 317 in the session setup procedure, then that given party can nevertheless be identified as a party to the call using the IP address of that given party's device used in establishing the session leg. The supplied IP address may then be used to send data to that given party's device throughout the ensuing communications session, even if the IP address is only temporarily allocated to the user device as a dynamic IP address. Hence, a static or dynamic IP address may be used, in some embodiments of the invention, to identify a call party and may be one of the call party identifiers which forms part of the call party details transmitted to the CSSP 107, 317, e.g. in a connection setup request during session establishment.

A unique identifier in any of the various forms described above, in a form other than that of a telephony dialing number, may be used to identify a given party to the call, in call party details transmitted by a user device associated with that given party. A unique identifier in any of the various forms described, in a form other than that of a telephony dialing number, may in addition, or in the alternative, be used to identify another party to the call, in call party details transmitted by that given party. The CSSP 107, 317 may supply the unique identifiers of other parties, using e.g. a synchronization process for populating an address book locally stored on the user device with such identifiers. Alternatively, such unique identifiers of other parties may already be stored by, or manually added by a user of the device, in the local address book. Further alternatively, the unique identifiers may be stored in a global address book stored on a remote device. At least one of the two parties may have a user device which is configured to look up, from a local data store (e.g. a local address book) or a remote data store (e.g. a global address book), a correspondence between the other party's telephone dialing number, or other received unique identifier, and a different unique identifier. The different unique identifier may then be used instead to identify the other party to the call in the call party details transmitted by at least one side of the call to the CSSP 107, 317.

In the above-described embodiments mobile telephony devices communicate via a PLMN 109, 309. Such a PLMN 109, 309 may be any of a variety of different cellular communications network types, including a 2G network such as a Global System for Mobile communications (GSM) network, a 3G network, such as a Universal Mobile Telecommunications System (UMTS) network or a 4G network such as a Long Term Evolution (LTE or LTE Advanced) network. Whilst the call setup and call data flow is preferably conducted via the PLMN, the communications relating to the separate data communications session, e.g. communications with the CSSP 107, 317, may be conducted via a different radio access network (RAN), such as a wireless local area network (WLAN) based on the IEEE 802.11 standards.

In the above-described embodiments, the TSP 106, 316 and the CSSP 107, 317 are described as a single computing device located in a single network location. However, it should be understood that the TSP 106, 316 and/or the CSSP 107, 317 may consist of a distributed set of computing devices or applications, either co-located in a single network location, or dispersed in different network locations.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of processing data in relation to a teleconference service in a telecommunications network, the teleconference service being able to handle a multi-party teleconference for three or more teleconference participants, the method comprising:
receiving a first teleconference participation identifier from a first teleconference participant;
receiving a second teleconference participation identifier from a second teleconference participant;
receiving a third teleconference participation identifier from a third teleconference participant;
correlating the first, second and third teleconference participation identifiers to determine that the first, second and third teleconference participants are participants in a given multi-party teleconference; and
transmitting data for enabling the establishment of a data communications session which is established separately from the teleconference, the data communications session being for the communication of data between a first data communication device associated with the first teleconference participant, a second data communication device associated with the second teleconference participant and a third data communication device associated with the third teleconference participant.

2. A method according to claim 1, wherein:
the first teleconference participation identifier is different from a telephone dialing number associated with the first data communication device;
the second teleconference participation identifier is different from a telephone dialing number associated with the second data communication device; and
the third teleconference participation identifier is different from a telephone dialing number associated with the third data communication device.

3. A method according to claim 1, comprising:
establishing a first telephony session with the first teleconference participant and receiving the first teleconference participation identifier via the first telephony session;
establishing a second telephony session with the second teleconference participant and receiving the second teleconference participation identifier via the second telephony session; and
establishing a third telephony session with the third teleconference participant and receiving the third teleconference participation identifier via the third telephony session.

4. A method according to claim 3, comprising:
receiving first multi-frequency signalling information via the first telephony session and determining the first teleconference participation identifier from the first multi-frequency signalling information;
receiving second multi-frequency signalling information via the second telephony session and determining the second teleconference participation identifier from the second multi-frequency signalling information; and
receiving third multi-frequency signalling information via the third telephony session and determining the third teleconference participation identifier from the third multi-frequency signalling information.

5. A method according to claim 3, comprising:
receiving the first teleconference participation identifier from the first teleconference participant via a first data communications session other than the first telephony session;
receiving the second teleconference participation identifier from the second teleconference participant via a second data communications session other than the second telephony session; and
receiving the third teleconference participation identifier from the third teleconference participant via a third data communications session other than the third telephony session.

6. A method according to claim 1, comprising:
receiving said first, second and third teleconference participation identifiers at a teleconference service provider that provides the teleconference service;
performing said correlation at the teleconference service provider; and
transmitting said data for enabling the establishment of the data communications session to a communications session service provider, the communications session service provider establishing the data communications session separately from the teleconference.

7. A method according to claim 1, wherein said data for enabling the establishment of a data communications session comprises correlation data identifying that the first, second and third teleconference participants are participants in the given multi-party teleconference.

8. A method according to claim 1, comprising:
receiving said first, second and third teleconference participation identifiers at a communications session service provider that establishes data communications sessions; and
performing said correlation at the communications session service provider.

9. A method according to claim 1, comprising:
receiving the first teleconference participation identifier from a first telephony device associated with the first teleconference participant;
receiving the second teleconference participation identifier from a second telephony device associated with the second teleconference participant;
receiving the third teleconference participation identifier from a third telephony device associated with the third teleconference participant, and wherein at least one of said first, second and third data communications devices is different from at least one of said first, second and third telephony devices.

10. A method of processing data in relation to a teleconference service in a telecommunications network, the teleconference service being able to handle a multi-party teleconference for three or more teleconference participants, the method comprising:
receiving a first request to establish a data communications session from a first teleconference participant;
receiving a second request to establish a data communications session from a second teleconference participant;
receiving a third request to establish a data communications session from a third teleconference participant;
determining that the first, second and third teleconference participants are participants in a given multi-party teleconference; and
establishing a data communications session separately from the teleconference, the data communication session being for the communication of data between a first data communications device associated with the first teleconference participant, a second data communications device associated with the second teleconference participant and a third data communications device associated with the third teleconference participant.

11. A method according to claim 10, comprising:
receiving correlation data identifying that the first, second and third teleconference participants in the given multi-party teleconference from a teleconference service provider that provides that teleconference service.

12. A method according to claim 10, comprising:
receiving said first request from a first mobile telephony device associated with the first teleconference participant;
receiving said second request from a second mobile telephony device associated with the second teleconference participant; and
receiving said third request from a third mobile telephony device associated with the third teleconference participant, and wherein at least one of said first, second and third data communications devices is different from at least one of said first, second and third telephony devices.

13. A method according to claim 10, comprising:
receiving a first teleconference participation identifier from the first teleconference participant;
receiving a second teleconference participation identifier from the second teleconference participant;
receiving a third teleconference participation identifier from the third teleconference participant; and
correlating the first, second and third teleconference participation identifiers to determine that the first, second and third teleconference participants are participants in a given multi-party teleconference.

14. A method of processing data in relation to a teleconference service in a telecommunications network, the teleconference service being able to handle a multi-party teleconference for three or more teleconference participants, the method comprising:
obtaining a first teleconference participation identifier associated with a given multi-party teleconference involving a first teleconference participant;
transmitting the teleconference participation identifier via a data communications session that is separate from the multi-party teleconference; and
establishing a multi-party data communications session for the communication of data between a first data communication device associated with the first teleconference participant, a second data communication device associated with a second teleconference participant and a third data communication device associated with a third teleconference participant, the first, second and third teleconference participants being participants in the given multi-party teleconference.

15. A method according to claim 14, comprising:
establishing a telephony session with a teleconference service provider that provides the given multi-party teleconference;
and transmitting the teleconference participation identifier via the telephony session.

16. A method according to claim 15, comprising:
transmitting multi-frequency signalling information via the telephony session, the multi-frequency signalling information comprising the teleconference participation identifier.

17. A method according to claim 15, comprising:
receiving the teleconference participation identifier via an input mechanism;
transmitting the teleconference participation identifier received via the input mechanism to the teleconference service provider;
capturing the teleconference participation identifier; and
transmitting the captured teleconference participation identifier to a communications session service provider.

18. A method according to claim 15, comprising:
receiving the teleconference participation identifier via an input mechanism;
transmitting the teleconference participation identifier received via the input mechanism to a communications session service provider;
capturing the teleconference participation identifier; and
transmitting the captured teleconference participation identifier to the teleconference service provider.

19-24. (canceled)
